(19) United States
(12) Patent Application Publication
(10) Pub. No.: US 2024/0284952 A1
(43) Pub. Date: Aug. 29, 2024

(54) SENSORY MODIFIERS FOR MEAT SUBSTITUTE COMPOSITIONS

(71) Applicant: CARGILL, INCORPORATED, Wayzata, MN (US)

(72) Inventors: Joseph PURL, Wichita, KS (US); Rama Krishna SARANGAPANI, St. Michael, MN (US); Wade Nolan SCHMELZER, St. Louis Park, MN (US); Conor SULLIVAN, Hopkins, MN (US)

(73) Assignee: CARGILL, INCORPORATED, Wayzata, MN (US)

(21) Appl. No.: 18/570,042

(22) PCT Filed: Jun. 17, 2022
(86) PCT No.: PCT/US2022/073010

§ 371 Date: Dec. 13, 2023

Related U.S. Application Data
(60) Provisional application No. 63/212,381, filed on Jun. 18, 2021.

(51) Int. Cl. A23L 27/00; A23J 3/14; A23J 3/22

(52) U.S. Cl. CPC A23L 27/84; A23J 3/14; A23J 3/227

(57) ABSTRACT

A meat substitute composition having a plant-based protein and a sensory modifier, such that the composition has reduced bitterness and/or plant protein flavor relative to an equivalent meat substitute composition without the sensory modifier. The sensory modifier may include a dicaffeoylquinic acid or salt thereof; and one or more compounds selected from the group consisting of monocaffeoylquinic acids, monoferuloylquinic acids, diferuloylquinic acids, monocoumaroylquinic acids, dicoumaroylquinic acids, and salts thereof.

### CROSS-REFERENCE TO RELATED APPLICATIONS

This application claims priority to U.S. Provisional Patent Application No. 63/212,381, filed Jun. 18, 2022, which is incorporated herein by reference in its entirety.

### BACKGROUND

Demand for plant-based meat substitutes is increasing for a variety of reasons. Many consumers prefer meat substitutes options that perform most similarly to animal meat. However, in some cases, consumers may discern that the sensory and temporal taste profile of meat substitutes prepared with plant-based proteins is bitter, has an unpleasant mouthfeel, and has an unpleasant aftertaste. These sensory attributes can limit consumers preferences for these products and limit the applications of meat substitute compositions.

### SUMMARY

The present disclosure provides compositions containing at least 2.0% (wt) of a plant-based protein; and between 0.001% (wt) and 1.0% (wt) of a sensory modifier comprising a dicaffeoylquinic acid or salt thereof; and at least one compound selected from the group consisting of monocaffeoylquinic acids, monoferuloylquinic acids, diferuloylquinic acids, monocoumaroylquinic acids, dicoumaroylquinic acids, and salts thereof. The plant-based protein may be selected from the group consisting of pea protein, soy protein, corn protein, potato protein, wheat protein, pulse protein, chickpea protein, canola protein, rice protein, sunflower protein, and combinations thereof.

The sensory modifier may comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than 0.05% (wt) of chlorophyll; or less than 0.1% (wt) of furans, furan-containing chemicals, theobromine, theophylline, or trigonelline as a weight percentage on a dry weight basis of the sensory modifier. The sensory modifier may comprise 0% (wt) of malonate, malonic acid, oxalate, oxalic acid, lactate, lactic acid, succinate, succinic acid, malate, or malic acid; or 0% (wt) of chlorophyll. The dicaffeoylquinic acid or dicaffeoylquinic salt may comprise at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. In some aspects, the total of all dicaffeoylquinic acids and dicaffeoylquinic salts present in the sensory modifier comprises 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the sensory modifier. The sensory modifier may comprise a monocaffeoylquinic component selected from the group consisting of chlorogenic acid, neochlorogenic acid, cryptochlorogenic acid, and salts thereof. The sensory modifier may comprise a monocaffeoylquinic component and a dicaffeoylquinic component that together comprise more than 50% (wt), preferably more than 60% (wt), more than 70% (wt), more than 80% (wt), more than 90% (wt), or more than 95% (wt) of the sensory modifier. The sensory modifier may be 0.001% to 0.5%, 0.005% to 0.1%, 0.01% to 0.05% by weight of the composition.

The composition can additionally comprise between 50% (wt) and 80% (wt), between 55% (wt) and 75% (wt), or between 58% (wt) and 70% (wt) of water. The meat substitute may comprise between 1% and 25%, between 1.5% and 20%, between 2% and 15%, between 2.5% and 10%, between 3% and 8%, or between 4% and 7% by weight of lipid composition. The lipid composition may comprise vegetable oil, coconut oil, palm oil, sunflower oil, soy oil, canola oil, or combinations thereof. The meat substitute may comprise between 2% and 30%, between 5% and 25%, between 8% and 20%, or between 10% and 19% by weight of a textured plant-based protein. The textured plant-based protein may comprise textured pulse protein, textured pea protein, textured soy flour, textured soy concentrate, textured wheat protein, textured potato protein, or combinations thereof. The meat substitute may comprise between 0.5% and 8%, between 1% and 6%, between 20% and 40%, or between 25% and 35% by weight of a non-textured plant-based protein. The non-textured plant-based protein may comprise pulse protein isolate, pea protein isolate, defatted soy flour, defatted soy isolate, defatted soy concentrate, vital wheat gluten, potato protein, corn protein isolate, or combinations thereof. The meat substitute may comprise methylcellulose in an amount up to 2% by weight or between 0.1% and 2% by weight.

For example, the disclosure provides a meat substitute composition wherein, when cooked to an internal temperature of 73.9° C., plant protein flavor intensity of the composition is reduced relative to plant protein flavor intensity in an equivalent composition prepared without the sensory modifier. The plant protein flavor may be a flavor selected from the group consisting of beany, pea, corny, hay, green notes, barnyard, fermented, waxy, and combinations thereof. When cooked to an internal temperature of 73.9° C., bitterness intensity of the meat substitute composition may be reduced relative to bitterness intensity in an equivalent composition prepared without the sensory modifier.

The disclosure also provides a method for decreasing plant protein flavor in a meat substitute composition, the method comprising, adding to a meat substitute composition comprising a plant-based protein a sensory modifier to make a modified meat substitute composition, the sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof, wherein, when cooked to an internal temperature of 73.9° C., plant protein flavor of the modified meat substitute composition is reduced relative to plant protein flavor in an equivalent meat substitute composition prepared without the sensory modifier. The plant protein flavor may be a flavor selected from the group consisting of beany, pea, corny, hay, green notes, barnyard, fermented, waxy, and combinations thereof. The bitterness intensity of the cooked modified meat substitute may be reduced relative to bitterness intensity in an equivalent meat substitute composition prepared without the sensory modifier.

The disclosure also provides a method for preparing a meat substitute composition with reduced plant-based protein flavor, the method comprising: (i) hydrating a textured plant-based protein with a first portion of water; (ii) combining a soluble plant-based protein, a gelling agent, and a second portion of water to form a dough; (iii) mixing the hydrated textured plant-based protein to the dough; and (iv) adding a lipid composition to the hydrated textured plant-based protein dough mixture wherein a sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof, is added in step (i), step (ii), step (iii), step (iv) or a combination thereof at a concentration of 0.001% to 1.0% by weight of the final meat substitute composition. In some aspects, the sensory modifier is added in step (ii). The meat substitute may comprise between 0.001% (wt) and 0.5% (wt) of the sensory modifier.

### BRIEF DESCRIPTION OF THE FIGURES

This patent or application contains at least one drawing executed in color. Copies of this patent or patent application publication with color drawings will be provided by the Office upon request and the payment of the necessary fee.

The drawings illustrate generally, by way of example, but not by way of limitation, various aspects discussed herein.

FIG. 1 shows pea protein patties prepared according to Example 1, including sample 1.1 (top left), sample 1.2 (top right), sample 1.3 (bottom left), and sample 1.4 (bottom right).

FIG. 2 shows the pea protein patties of FIG. 1 after cooking to an internal temperature of 165° F. (about 73.9° C.) with browning on both sides.

FIG. 3 shows pea protein patties prepared according to Example 3, including sample 1.1 (left), sample 1.5 (center), and sample 1.6 (right).

FIG. 4 shows the pea protein patties of FIG. 3 after cooking to an internal temperature of 165° F. (about 73.9° C.) with browning on both sides.

FIGS. 5A-5E show photos of the plant-based protein solutions prepared according to Example 8.

FIGS. 6A-6D show photos of the pea protein isolate solutions prepared according to Example 9.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

This disclosure relates to various meat substitute compositions which have improved sensory attributes, such as reduced plant protein favor, reduced aftertaste, improved mouthfeel, reduced waxiness, more consistent flavor, and/or reduced bitterness. The disclosure also relates, generally, to a sensory modifier and uses thereof. In various aspects, the sensory modifier contains one or more caffeoyl-substituted quinic acid, and salts thereof. The disclosure further relates to methods of reducing undesirable attributes associated with plant-protein based meat substitutes and providing an improved composition relative to meat substitutes which lack the sensory modifier described herein.

### Compositions

The present disclosure provides meat substitute compositions containing a non-meat protein (e.g., a plant-based protein) and various improvements which serve to modify the sensory perception thereof in use.

As used herein, the terms “meat substitute” and “meat substitute composition” are used interchangeably and refer to compositions that mimic the general appearance, nutritional content, and/or taste of natural animal meat or natural animal meat compositions without containing as the majority component tissues or cells from a whole, living vertebrate animal. For example, a meat substitute mimics an animal meat composition but does not include protein derived from the tissue of an animal. In some aspects, the meat substitute is free of any animal protein, including any milk protein or egg protein. On some aspects, the meat substitute is free of tissue derived animal protein by may include milk and/or egg proteins. The meat substitute composition may include a textured plant-based protein, a non-textured plant-based protein (e.g., a powdered plant-based protein, a plant-based protein isolate, a plant-protein based flour, a plant-protein concentrate), or combinations thereof.

As used herein, “textured protein” and “textured plant-based protein” are used interchangeably and refer to edible food ingredients processed from an edible protein sources and characterized by having a structural integrity and identifiable structure such that individual units, appearing as fibers, shreds, chunks, bits, granules, slices, and the like, will withstand hydration and cooking or other procedures used in the production of food for consumption. In general, textured plant-based proteins are used to mimic the texture of meat and bind water in the meat substitute compositions. Edible protein sources from which textured proteins are produced may include, but are not limited to, legumes (e.g., pulse protein), pea, soy, corn, wheat, chickpea, potato, canola, rice, sunflower, and the like. For example, textured proteins may include, but are not limited to, textured pulse protein, textured pea protein, textured soy flour, textured soy concentrate, textured wheat protein, textured potato protein, or combinations thereof. Methods for protein texturization and known and described in the art, and may include, for example, high temperature and pressure extrusion, spinning, freeze texturization, chemical or enzymatic texturization, and the like.

Meat substitutes described herein may also include a non-textured plant-based protein, for example, a powdered plant-based protein, a plant-based protein isolate, a plant-protein based flour, a plant-protein concentrate, combinations thereof, and the like. Powdered plant-based proteins and plant-based protein isolates can include soluble forms of plant-based proteins used as food ingredients. Edible protein sources from which non-textured proteins may be produced include, but are not limited to, legumes (e.g., pulse protein), pea, soy, corn, wheat, chickpea, potato, canola, rice, sunflower, and the like. For example, non-textured plant-based proteins may include, but are not limited to, legume (e.g., pulse protein), pea protein, defatted soy flour, defatted soy isolate, soy concentrate, vital wheat gluten, potato protein, corn protein isolate, or combinations thereof.

As used herein, the term “non-meat protein” refers to protein sourced from plants, fungus, insects, or dairy products, and excludes in vivo vertebrate animal derived tissues, cells, or proteins. For example, non-meat proteins may include plant-based proteins, fungal-based proteins, insect proteins, milk proteins (e.g., casein and whey), egg proteins, or combinations thereof. The meat substitute can comprise a combination of two or more of plant-based protein, fungal-based proteins, and insect proteins.

Suitable fungal-based proteins include, but are not limited to, mycoproteins from Fusarium venenatum. Fungal-based proteins may be incorporated into the meat substitute composition in the form of fungal and/or microbial biomass, or in the form of a fungal extract, including, but not limited to a Fusarium venenatum extract.

In some aspects, the meat substitute can mimic a beef product, e.g., ground beef, steak, beef jerky, beef ribs, beef patties, beef sausages, and the like. In some aspects, the meat substitute can mimic a pork product, e.g., ground pork, pork chops, ham, smoked pork, bacon, pork sausage, pork patties, pork ribs, and the like. In some aspects, the meat substitute can mimic a chicken product, e.g., ground chicken, chicken breast, check legs, chicken thighs, chicken wings, chicken patties, chicken tenders, chicken nuggets, chicken sausage, and the like. In some aspects, the meat substitute can mimic a turkey product, e.g., ground turkey, turkey sausage, turkey patties, and the like. In some aspects, the meat substitute can mimic a whole muscle fish product, e.g., salmon, tuna, and the like. In some aspects, the meat substitute can mimic a shellfish product, e.g., crab, lobster, shrimp, crayfish, clams, scallops, oysters, mussels, and the like. In some aspects, the meat substitute can mimic a cured, salted, fermented, or processed meat product, e.g., charcuterie, salami, summer sausage, prosciutto, bologna, kielbasa, and the like.

In general, a meat substitute composition described herein includes a non-meat protein (e.g., a plant-based protein), and optionally include water, a lipid composition, fiber, starch, a gelling agent (e.g., methylcellulose), a preservative, a pigment, a flavor, or combinations thereof. The meat substitute may be in a form that mimics a ground and formed meat (e.g., ground beef, sausage, or another meat product in which the raw meat has been ground and reformed), a deli or emulsified meat (e.g., hot dogs, bologna, and other processed meats), or a cut from whole muscle (e.g., chicken breast, steak, and the like that are from whole muscles from an animal). The meat substitute may include a textured plant-based protein, a non-textured plant-based protein, or combinations thereof. The meat substitute may include between 2% and 30%, between 5% and 25%, between 8% and 20%, or between 10% and 19% by weight of a textured plant-based protein. The meat substitute may include between 0.5% and 8%, between 1% and 6%, between 20% and 40%, or between 25% and 35% by weight of a non-textured plant-based protein.

The textured plant-based protein may be a product of high moisture processing, e.g., extrusion. For example, between 2% and 30%, between 5% and 25%, between 8% and 20%, or between 10% and 19% by weight of a plant-based protein may be used in high moisture processing to form a high moisture textured protein product. In general, the plant-based protein may be added to the high moisture processing as part of a slurry, optionally also including fiber, starch, and the like.

The meat substitute may include one or more lipid compositions, for example a fat, an oil, or combinations thereof. In general, fats refer to lipid compositions that are solid at room temperature, whereas oils are liquid at room temperature. The lipid compositions may include saturated fatty acids (also referred to as “saturated fats”), unsaturated fatty acids (also referred to as “unsaturated fats”), or combinations thereof, typically in the form of mono-, di-, or tri-acyl glycerides instead of as free fatty acid. The lipid composition may include, but are not limited to, vegetable oil, coconut oil, palm oil, sunflower oil, soy oil, canola oil, or combinations thereof. The meat substitute composition may include between 1% and 25%, between 1.5% and 20%, between 2% and 15%, between 2.5% and 10%, between 3% and 8%, or between 4% and 7% by weight of a lipid composition.

In some aspects, the meat substitute may include a lipid mimetic instead of or in addition to a lipid composition described herein. As used herein, the term “lipid mimetic” refers to a compound or composition that mimics the form, function, texture, mouthfeel, and taste of a lipid composition when used as a food ingredient, but has a lower fat content than the lipid it replaces. A lipid mimetic for use in the meat substitute composition describe herein may include, but is not limited to, a fiber, a starch, a carbohydrate, a protein, hydrated forms thereof, structured forms thereof, or combinations thereof. In some aspect, the lipid mimetic may be a plant extract. The meat substitute composition may include between 1% and 25%, between 1.5% and 20%, between 2% and 15%, between 2.5% and 10%, between 3% and 8%, or between 4% and 7% by weight of a lipid mimetic. When the lipid mimetic is used in combination with a lipid composition, the meat substitute may include between 1% and 25%, between 1.5% and 20%, between 2% and 15%, between 2.5% and 10%, between 3% and 8%, or between 4% and 7% by weight of the combination of the lipid mimetic and the lipid composition.

The meat substitute may include water. For example, the meat substitute may include between 50% (wt) and 80% (wt), between 55% (wt) and 75% (wt), or between 58% (wt) and 70% (wt) of water. In some aspects, some or all of the water may be included in a a high-moisture textured protein product.

In some aspects, the meat substitute composition may be a dry mix meat substitute composition that is rehydrated before use. For example, the dry mix meat substitute composition may be free of added water, but, when reconstituted with a suitable amount of water will form a meat substitute composition as described herein. In some aspects, a dry mix meat substitute composition may include between 75% and 100% by weight of a textured plant-based protein, and optionally including a fiber, a starch, a powdered lipid composition, a gelling agent, a preservative, a pigment, a flavor, and/or a seasoning at a concentration such that, when reconstituted with water the resulting meat substitute compositions includes the ingredients at concentrations described herein.

The meat substitute may include fiber. The fiber may include, but is not limited to, pectin, apple fiber, psyllium, flax fiber, rice bran extract, Konjac flour, and the like. The meat substitute may include between 0.1% (wt) and 3% (wt), between 0.1% (wt) and 2% (wt), or between 0.5% (wt) and 2% (wt) of fiber. The meat substitute may include fiber in an amount up to 1% (wt), up to 1.5% (wt), up to 2% (wt), up to 2.5% (wt), or up to 3% (wt).

The meat substitute may include starch. The starch may include a pregelatinized starch, a modified starch, or combinations thereof. The starch may include, but is not limited to, corn starch, potato starch, tapioca starch, and the like. The meat substitute may include between 0.1% (wt) and 3% (wt), between 0.1% (wt) and 2% (wt), or between 0.5% (wt) and 2% (wt) of starch. The meat substitute may include starch in an amount up to 1% (wt), up to 1.5% (wt), up to 2% (wt), up to 2.5% (wt), or up to 3% (wt).

The meat substitute may include a gelling agent. The gelling agent may include, but is not limited to, methylcellulose, egg white protein, casein, pectin, hydrocolloids (e.g. guar gum, xanthan gum, locust bean gum, and the like), a crosslinking enzyme (e.g., transglutaminase), and combinations thereof. In some aspects, using plant-based proteins such as soy, canola, or potato protein may eliminate or reduce the need to add a gelling agent. The meat substitute may include between 0.1% (wt) and 3% (wt), between 0.1% (wt) and 2% (wt), or between 0.5% (wt) and 2% (wt) of a gelling agent. The meat substitute may include a gelling agent in an amount up to 1% (wt), up to 1.5% (wt), up to 2% (wt), up to 2.5% (wt), or up to 3% (wt).

In some aspects, the gelling agent is methylcellulose. The meat substitute may include between 0.1% (wt) and 3% (wt), between 0.1% (wt) and 2% (wt), or between 0.5% (wt) and 2% (wt) of methylcellulose. The meat substitute may include methylcellulose in an amount up to 1% (wt), up to 1.5% (wt), up to 2% (wt), up to 2.5% (wt), or up to 3% (wt).

The meat substitute may include a preservative. For example, the meat substitute may include a preservative such as potassium sorbate, cultured dextrose, vinegar, and the like.

The meats substitute may include a pigment. Pigments for meat substitute compositions are known and described in the art and may include, but are not limited to, fruit and vegetable extracts (e.g., beet juice and beet extracts), heme-containing proteins, and the like.

The meat substitute may include a flavor or a seasoning. For example, the meat substitute may include a natural or artificial flavor and/or seasoning. Seasonings may include, but are not limited to, yeast extract, spices, paprika, garlic (e.g., garlic powder, minced garlic, dehydrated garlic), onion (e.g., onion powder, minced onion, dehydrated onion), oregano, parsley, sweetener, salt (e.g., sodium chloride or potassium chloride), cayenne, chili powder, cumin, ginger, and the like.

The meat substitute may include a sweetener. Suitable sweeteners are known and described in the art. The sweetener can be at least one of a non-caloric sweetener or a caloric sweetener. The sweetener can be any type of sweetener, for example, a sweetener obtained from a plant or plant product, or a physically or chemically modified sweetener obtained from a plant, or a synthetic sweetener. Exemplary sweeteners include steviol glycosides, mogrosides, sucrose, fructose, glucose, erythritol, maltitol, lactitol, sorbitol, mannitol, xylitol, tagatose, trehalose, galactose, rhamnose, cyclodextrin (e.g., a-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, sucralose, acesulfame K, aspartame, saccharin, coupling sugars, soybean oligosaccharides, and combinations thereof. D- or L-configurations can be used when applicable. Suitable sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

### Sensory Modifier

A sensory modifier is a compound or composition that in certain amounts changes the sensory characteristics or sensory attributes of a consumable, e.g., a beverage, a food product, etc. Non-limiting examples of sensory characteristics that a sensory modifier can change include bitterness, sourness, numbness, astringency, creaminess, metallicness, cloyingness, dryness, sweetness, starchiness, mouthfeel, temporal aspects of sweetness, temporal aspects of saltiness, temporal aspects of bitterness, or temporal aspects of any sensory characteristic described herein, as well as flavor notes, such as licorice, vanilla, prune, cotton candy, lactic, umami, and molasses flavor notes. The sensory modifier may enhance a sensory characteristic, such as enhancing creaminess; may suppress a sensory characteristic, such as reducing bitterness or reducing plant-protein flavor; or may change the temporal aspects of a sensory characteristic, e.g., by reducing plant-protein flavor lingering, or a combination thereof. In some aspects, the amount employed in a meat substitute or plant-based protein composition having a plant-based protein and one or more sensory modifiers alters at least one sensory characteristic, e.g., the combination may have reduced bitterness or reduced plant-protein flavor compared to the meat substitute or plant-based protein composition without the sensory modifiers.

The present disclosure provides a sensory modifier comprising one or more caffeoyl-substituted quinic acids, and salts thereof. In various aspects, the caffeoyl-substituted quinic acids comprise an ester derived from the carboxylic acid of caffeic acid and an alcohol of quinic acid. A “caffeoyl-substituted quinic acid” or “caffeoylquinic acid” as the terms are used herein, include monocaffeoylquinic acids and dicaffeoylquinic acids and salts thereof. Monocaffeoylquinic acids comprise an ester derived from a single caffeic acid and a quinic acid (e.g., chlorogenic acid (5-O-caffeoylquinic acid), neochlorogenic acid (3-O-caffeoylquinic acid), and cryptochlorogenic acid (4-O-caffeoylquinic acid)). Dicaffeoylquinic acids comprise an ester derived from two caffeic acids and a quinic acid (e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid)). Thus, the sensory modifier includes both acid forms and salt forms of caffeoyl-substituted quinic acids. Free acid forms of various caffeoyl-substituted quinic acids are shown in Table 1.

TABLE 1
Structures of various caffeoyl-substituted quinic acids.

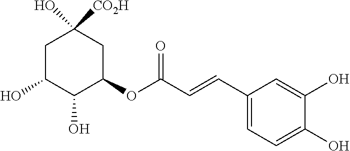 [SMILES: O=C(/C=C/c1ccc(O)c(O)c1)O[C@@H]1C[C@](O)(C(=O)O)C[C@@H](O)[C@H]1O]

Chlorogenic acid (5-O-caffeoylquinic acid)

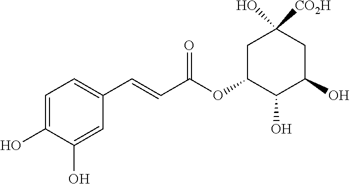 [SMILES: O=C(/C=C/c1ccc(O)c(O)c1)O[C@@H]1C[C@@](O)(C(=O)O)C[C@@H](O)[C@@H]1O]

Neochlorogenic acid (3-O-caffeoylquinic acid)

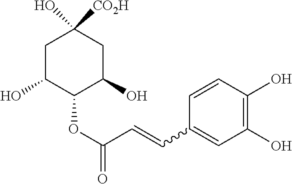 [SMILES: O=C(C=Cc1ccc(O)c(O)c1)O[C@H]1[C@H](O)C[C@](O)(C(=O)O)C[C@H]1O]

Cryptochlorogenic acid (4-O-caffeoylquinic acid)

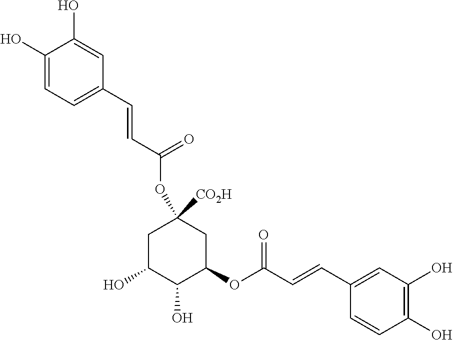 [SMILES: O=C(/C=C/c1ccc(O)c(O)c1)O[C@@H]1C[C@](OC(=O)/C=C/c2ccc(O)c(O)c2)(C(=O)O)C[C@@H](O)[C@H]1O]

1,5-Dicaffeoylquinic acid

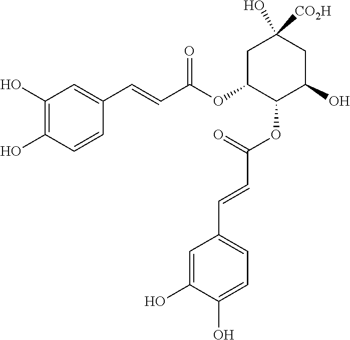 [SMILES: O=C(/C=C/c1ccc(O)c(O)c1)O[C@H]1[C@H](O)C[C@](O)(C(=O)O)C[C@H]1OC(=O)/C=C/c1ccc(O)c(O)c1]

3,4-Dicaffeoylquinic acid

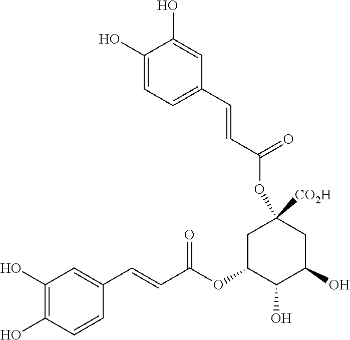 [SMILES: O=C(/C=C/c1ccc(O)c(O)c1)O[C@@H]1C[C@@](OC(=O)/C=C/c2ccc(O)c(O)c2)(C(=O)O)C[C@@H](O)[C@@H]1O]

1,3-Dicaffeoylquinic acid

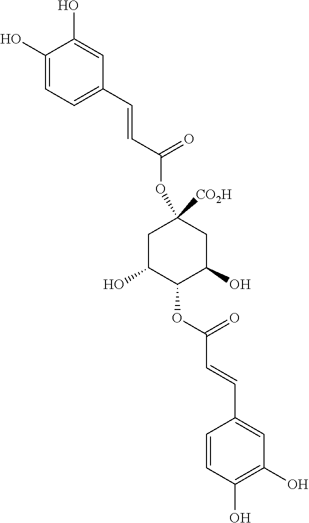 [SMILES: O=C(/C=C/c1ccc(O)c(O)c1)O[C@H]1[C@H](O)C[C@](OC(=O)/C=C/c2ccc(O)c(O)c2)(C(=O)O)C[C@H]1O]

1,4-Dicaffeoylquinic acid

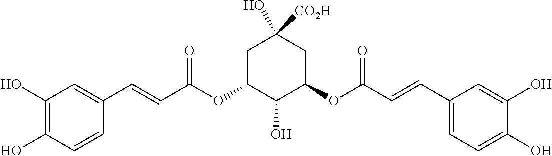 [SMILES: O=C(/C=C/c1ccc(O)c(O)c1)O[C@@H]1C[C@](O)(C(=O)O)C[C@@H](OC(=O)/C=C/c2ccc(O)c(O)c2)[C@H]1O]

3,5-Dicaffeoylquinic acid

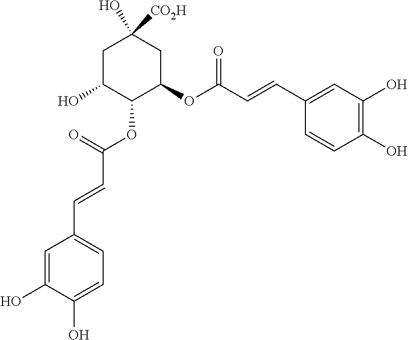 [SMILES: O=C(/C=C/c1ccc(O)c(O)c1)O[C@@H]1[C@H](O)C[C@@](O)(C(=O)O)C[C@H]1OC(=O)/C=C/c1ccc(O)c(O)c1]

4,5-Dicaffeoylquinic acid

In various aspects, the sensory modifier further comprises one or more of quinic acid, caffeic acid, ferulic acid, sinapic acid, p-coumaric acid, an ester of quinic acid, an ester of caffeic acid, an ester of ferulic acid, an ester of sinapic acid, an ester of p-coumaric acid, an ester of caffeic acid and quinic acid, an ester of caffeic acid and quinic acid comprising a single caffeic acid moiety, an ester of caffeic acid and quinic acid comprising more than one caffeic acid moiety, an ester of ferulic acid and quinic acid, an ester of ferulic acid and quinic acid comprising a single ferulic acid moiety, an ester of ferulic acid and quinic acid comprising more than one ferulic acid moiety, an ester of sinapic acid and quinic acid, an ester of sinapic acid and quinic acid comprising a single sinapic acid moiety, an ester of sinapic acid and quinic acid comprising more than one sinapic acid moiety, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety, a di-ester of quinic acid containing one caffeic acid moiety and one ferulic acid moiety, a caffeic ester of 3-(3,4-dihydroxyphenyl)lactic acid, a caffeic acid ester of tartaric acid, a caffeic acid ester of tartaric acid containing more than one caffeic acid moieties, and/or isomers thereof, and the corresponding salts.

In some aspects, the sensory modifier comprises one or more of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, rosmarinic acid, caftaric acid (monocaffeoyltartaric acid), cichoric acid (dicaffeoyltartaric acid) and salts, and/or isomers thereof, and the corresponding salts.

In some aspects, the sensory modifier consists essentially of one or more compounds selected from the list consisting of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and any combination thereof, isomers thereof, and the corresponding salts. In various aspects, one or more alcohol of the caffeoyl moiety is replaced with a hydrogen or substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate. Thus, modified and substituted caffeic acid moieties result in a cinnamic acid, o-coumaroyl, p-coumaric acid, m-coumaric acid, ferulic acid, and the acyl and ester forms thereof. In various aspects, one or more alcohol of the quinic acid moiety is substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate.

The sensory modifier can include one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Examples of a ferulic ester of quinic acid includes 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, and combinations thereof. An example of a caffeic ester of 3-(3,4-dihydroxyphenyl)lactic acid is rosmarinic acid. Examples of a caffeic acid ester of tartaric acid includes cichoric acid (dicaffeoyltartaric acid) and caftaric acid (monocaffeoyltartaric acid) and combinations thereof.

In an alternative aspect, the sensory modifier is a mixture consisting of one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Such sensory modifier also includes salts thereof so as to have a salt fraction and an acid fraction. It is thus further envisaged that each of the various aspects described herein related to caffeoylquinic acid and other sensory modifiers can be equally applicable to this alternative.

Caffeic acid has the structure:

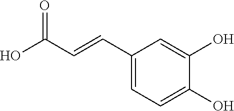 [SMILES: O=C(O)/C=C/c1ccc(O)c(O)c1]

Quinic acid has the structure:

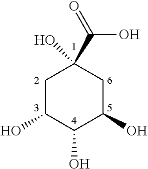 [SMILES: O=C(O)[C@]1(O)C[C@@H](O)[C@@H](O)[C@H](O)C1]

The structure provided above is D-(−)-quinic acid and the numbers shown correspond to current IUPAC numbering.

In various aspects, the sensory modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the sensory modifier. A sensory modifier that is enriched for one or more of caffeic acid, monocaffeoylquinic acids, and dicaffeoylquinic acids can modify the sensory attributes of the meat substitute composition.

The sensory modifier enriched for one or more dicaffeoylquinic acids can modify the sensory attributes of a meat substitute composition. A sensory modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more dicaffeoylquinic acids as a percentage of the total weight of the sensory modifier.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be monocaffeoylquinic acids and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be chlorogenic acid (5-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be neochlorogenic acid (3-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be cryptochlorogenic acid (4-O-caffeoylquinic acid) and salts thereof.

In various further aspects, at least or about 10 wt %, 15 wt %, 20 wt %, 25 wt %, 30 wt %, 35 wt %, 40 wt %, 45 wt %, or at least or about 50 wt % of the total sensory modifier can be 1,3-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 4,5-dicaffeoylquinic acid and salts thereof.

The sensory modifier can, for example, have a weight ratio of total monocaffeoylquinic acids and salts to total dicaffeoylquinic acids and salts of 20:1 to 1:20, e.g., from 3:1 to 1:20. In various aspects, the sensory modifier has a weight ratio from 15:1 to 1:15, from 10:1 to 1:10, from 5:1 to 1:5, from 3:1 to 1:3, from 2:1 to 1:2, from 1.5:1 to 1:1.5, from 5:1 to 1:1, from 3:1 to 1:1, from 2:1 to 1:1, from 1.5:1 to 1:1.1, from 1:1 to 1:20, from 1:1 to 1:15, from 1:1 to 1:10, from 1:5 to 1:20, from 1:5 to 1:15, from 1:5 to 1:10, from 1:2 to 1:20, from 1:2 to 1:15, from 1:2 to 1:10, from 1:2 to 1:5, from 1:1 to 1:3, from 1:1 to 1:2, or from 1:1 to 1:1.5 monocaffeoylquinic acid and salts thereof: dicaffeoylquinic acids and salts thereof. In some aspects, the sensory modifier has a greater amount, by weight, of dicaffeoylquinic acids and salts of dicaffeoylquinic acids compared to the amount of monocaffeoylquinic acids and salts of monocaffeoylquinic acids. In various aspects, the sensory modifier has a ratio of about 1:1 of monocaffeoylquinic acid:dicaffeoylquinic acids, including salts thereof.

The sensory modifier provided herein may contain a portion that is in salt form (corresponding to a “salt fraction”) and a portion that is in acid form (corresponding to an “acid fraction”). In various aspects, the salt fraction accounts for at least 50 wt % of the total sensory modifier. In various aspects, the sensory modifier comprises a salt fraction and an acid fraction, wherein the salt fraction comprises one or more of a salt of a monocaffeoylquinic acid and a salt of a dicaffeoylquinic acid, wherein the acid fraction comprises one or more of a monocaffeoylquinic acid and a dicaffeoylquinic acid, and wherein the salt fraction comprises at least 50 wt % of the total sensory modifier.

For example, the salt fraction comprises at least or about 50 wt %, 55 wt %, 60 wt %, 65 wt %, 70 wt %, 75 wt %, 80 wt %, 85 wt %, or at least or about 90 wt % of the total sensory modifier. In further aspects, the salt fraction comprises less than or about 60 wt %, 65 wt %, 70 wt %, 75 wt %, 80 wt %, 85 wt %, or less than or about 90 wt % of the total sensory modifier. In yet further aspects, the salt fraction comprises 50 wt % to 90 wt %, 50 wt % to 80 wt %, 50 wt % to 75 wt %, 60 wt % to 90 wt %, 60 wt % to 80 wt %, 65 wt % to 80 wt %, or 65 wt % to 75 wt % of the total sensory modifier. Unless otherwise specified the wt % of the salt fraction should be calculated inclusive of the balancing cation species.

In further examples, the acid fraction comprises at least or about 5 wt %, 10 wt %, 15 wt %, 20 wt %, 25 wt %, 30 wt %, 35 wt %, 40 wt %, or at least or about 45 wt % of the total sensory modifier. In further aspects, the acid fraction comprises less than or about 10 wt %, 15 wt %, 20 wt %, 25 wt %, 30 wt %, 35 wt %, 40 wt %, or less than about 50 wt % of the total sensory modifier. In yet further aspects, the acid fraction comprises 5 wt % to 50 wt %, 10 wt % to 50 wt %, 15 wt % to 50 wt %, 20 wt % to 50 wt %, 5 wt % to 40 wt %, 10 wt % to 40 wt %, 15 wt % to 40 wt %, 20 wt % to 40 wt %, 5 wt % to 35 wt %, 10 wt % to 35 wt %, 15 wt % to 35 wt %, 20 wt % to 35 wt %, 5 wt % to 30 wt %, 10 wt % to 30 wt %, 15 wt % to 30 wt %, 20 wt % to 30 wt %, 5 wt % to 20 wt %, 10 wt % to 20 wt %, 15 wt % to 20 wt %, 5 wt % to 15 wt %, 10 wt % to 15 wt %, or 5 wt % to 10 wt % of the total sensory modifier.

In various aspects, e.g., in an aqueous solution, the salt form of the total sensory modifier exists in equilibrium with the acid form. For example, a particular salt form molecule can become protonated and thus convert into the acid form and an acid form molecule can be come deprotonated to result in a salt form. After approaching or achieving equilibrium, such interplay will not substantially alter the overall wt % of a given form or fraction of the total sensory modifier. For example, a composition having a salt fraction of 50 wt % or more of the total sensory modifier can maintain the same proportions of salt and acid fractions even though the various compounds might exchange from one fraction to another.

There are also cases where the equilibrium between salt and acids forms can shift in response to the addition of components to the composition. For example, addition of buffer solution, salts, acid, or base can shift the equilibrium to favor the salt or acid fraction, and thus alter the wt % of the composition.

In various other aspects, e.g., in a solid composition, the salt form and acid forms can be in a solid state, in which the proportion between salt and acid forms is frozen. It should be understood that, in various aspects, the ratio of the salt fraction to acid fraction in a solid composition, such as a granulated salt composition, can differ from that of a resulting solution to which the solid composition is added. For example, in some aspects, a solid state salt composition will, upon dissolving or disintegrating, result in a solution having a sensory modifier of which at least 50 wt % is in salt form.

### Effective Amount of Sensory Modifier

The compositions of the present disclosure comprise a sensory modifier in an amount effective to reduce plant protein flavor intensity and off-tastes of the meat substitute composition relative to an equivalent meat substitute composition without the sensory modifier.

As used herein, “plant protein flavor” refers to the characteristic flavor(s) associated with and expected from plant-based proteins when said plant-based proteins are used as ingredients in food and beverage products. For example, plant protein flavors include beany, pea, corny, hay, green notes, barnyard, fermented, waxy, and combinations thereof that are usually found and expected from a plant-based protein. In general, certain characteristic plant protein flavors can be attributed to certain plant-based proteins. For example, pea proteins may be associated with green notes, pea flavor, and hay flavor; soy proteins may be associated with beany flavor and hay flavor, corn proteins may be associated with corny flavor and hay flavor, and potato proteins may be associated with barnyard flavor and fermented flavor.

As used herein, “off-taste(s)” refer to a taste or flavor profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

A sensory panel can be used to determine the magnitude of reduction in plant-protein flavor or shifts in its temporal profile, thereby quantifying the amount of sensory modifier effective to reduce plant-protein flavor. Sensory panels are a scientific and reproducible method that is essential to the food science industry. A sensory panel involves a group of two or more individual panelists. Panelists are instructed according to industry-recognized practices to avoid the influence of personal subjectivity and strengthen reproducibility. For example, panelists will objectively evaluate sensory attributes of a tested product but will not provide subjective attributes such as personal preference. In various aspects, the sensory panel can be conducted with two, three, four, five, six or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g. saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including, if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; coffee solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint, 3=slight, 4=mild, 5=moderate, 6=definite, 7=strong, 8=very strong, 9=extreme). Equivalent scales and methodologies can be used for sweet, bitter, sour, and umami sensory attributes.

As a further example, saltiness of a composition can be tested by a panel of at least two panelists. The panelists can use a standard range of 0.18% (wt), 0.2% (wt), 0.35% (wt), 0.5% (wt), 0.567% (wt), 0.6% (wt), 0.65% (wt), and 0.7% (wt) sodium chloride solutions in water corresponding to a saltiness intensity value of 2, 2.5, 5, 8.5, 10, 11, 13, and 15, respectively. A skilled artisan will recognize that depending on the sample/composition being tested, the number and range of standard solutions may be changed (e.g., using only the solutions corresponding to the 2, 2.5, and 5 saltiness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a saltiness intensity value between 0 and 15 for each composition based on comparison to the aforementioned standard sodium chloride solutions. Between tasting compositions, the panelists are able to cleanse their palates with water. The panelists also can taste the standard 0.18%, 0.2%, 0.35%, 0.5%, 0.567%, 0.6%, 0.65%, and 0.7% sodium chloride solutions ad libitum between tasting test solutions to ensure recorded saltiness intensity values are accurate against the scale of the standard sodium chloride solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Saltiness Intensity Test.”

Sourness of a composition can be tested by a panel of at least two panelists. The panelists can use a standard range of 0.035% (wt), 0.05% (wt), 0.07% (wt), 0.15% (wt), and 0.2% (wt) citric acid solutions in water corresponding to a sourness intensity value of 2, 3, 5, 10, and 15, respectively. A skilled artisan will recognize that depending on the sample/composition being tested, the number and range of standard solutions may be changed (e.g., using only the solutions corresponding to the 2 and 7 sourness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sourness intensity value between 0 and 15 for each composition based on comparison to the aforementioned standard citric acid solutions. Between tasting compositions, the panelists are able to cleanse their palates with water. The panelists also can taste the standard 0.035%, 0.05%, 0.07%, 0.15%, and 0.2% citric acid solutions ad libitum between tasting test solutions to ensure recorded sourness intensity values are accurate against the scale of the standard citric acid solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sourness Intensity Test.”

Bitterness of a composition can be tested by a panel of at least two panelists. The panelists can use a standard range of 0.0125% (wt), 0.01875% (wt), 0.025% (wt), 0.031% (wt), 0.07% (wt), and 0.12% (wt) caffeine solutions in water corresponding to a bitterness intensity value of 2, 3, 4, 5, 10, and 15, respectively. A skilled artisan will recognize that depending on the sample/composition being tested, the number and range of standard solutions may be changed (e.g., using only the solutions corresponding to the 2, 3, and 5 bitterness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a bitterness intensity value between 0 and 15 for each composition based on comparison to the aforementioned standard caffeine solutions. Between tasting compositions, the panelists are able to cleanse their palates with water. The panelists also can taste the standard 0.0125%, 0.01875%, 0.025%, 0.031%, 0.07%, and 0.12% caffeine solutions ad libitum between tasting test solutions to ensure recorded bitterness intensity values are accurate against the scale of the standard caffeine solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Bitterness Intensity Test.”

Sweetness of a composition can be tested by a panel of at least two panelists. The panelists can use a standard range of 2% (wt), 5% (wt), 8% (wt), 10% (wt), and 15% (wt) sucrose solutions corresponding to a sweetness intensity value of 2, 5, 8, 10, and 15, respectively. A skilled artisan will recognize that depending on the sample/composition being tested, the number and range of standard solutions may be changed (e.g., using only the solutions corresponding to the 2, 5, and 8 sweetness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sweetness intensity value between 0 and 15 for each composition based on comparison to the aforementioned standard sucrose solutions. Between tasting compositions, the panelists are able to cleanse their palates with water. The panelists also can taste the standard 2%, 5%, 8%, 10%, and 15% sucrose solutions ad libitum between tasting test solutions to ensure recorded sweetness intensity values are accurate against the scale of the standard sucrose solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sweetness Intensity Test.”

Umami of a composition can be tested by a panel of at least two panelists. The panelists can use a standard range of 0.75% (wt) and 0.125% (wt) monosodium glutamate (MSG) solutions corresponding to an umami intensity value of 4 and 6.5, respectively. A skilled artisan will recognize that depending on the sample/composition being tested, the number and range of standard solutions may be changed (e.g., adding additional umami solutions if the umami intensity is expected to be appreciably outside of the umami intensity value of 4-6.5). For each test composition, the panelists dispenses approximately 2-5 mL, for liquid compositions or solutions prepared with water, or 5-10 g, for solid compositions, of each composition into their own mouths, disperses the composition by moving their tongues/chewing, and records an umami intensity value between 0 and 15 for each composition based on comparison to the aforementioned standard MSG solutions. Between tasting compositions, the panelists are able to cleanse their palates with water. The panelists also can taste the standard 0.075% and 0.125% MSG solutions ad libitum between tasting test solutions to ensure recorded umami intensity values are accurate against the scale of the standard MSG solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Umami Intensity Test.”

A control sample is typically used as a reference point or for comparison purposes. For example, a control sample can be used to qualify the effectiveness of a sensory modifier. The control sample can be a composition such as a composition as described herein, but without the presence of the sensory modifier. Other than the sensory modifier, the control sample is otherwise the same, and it should contain the same component(s) and other ingredients at the same relative concentrations. Other standard samples are commonly used in sensory panels, for example standard samples used to evaluate intensity of sensory attributes as outlined above. In other aspects, the control sample may be a modified control sample which contains a different sensory modifier such as a competitor sensory modifier.

This disclosure is not limited to sensory testing by experienced or trained panelists. For example, it is possible to utilize untrained and inexperienced panelists. However, in the case of untrained and inexperienced panelists, a greater number of these panelists is usually necessary to provide reproducible results, which will typically focus on subjective attributes such as preference or overall liking. Similarly, untrained and inexperienced panelists may be asked to evaluate relative changes in a given sensory attribute between two samples. For example, if a particular sample is more or less salty, more or less sweet, more or less bitter, etc., than a reference sample.

An exemplified sensory assay and test criteria for further sensory attributes are described in the Examples provided in this disclosure. Additional description regarding roundtable sensory panels and sensory testing is set forth in PCT/US2018/054743, published Apr. 11, 2019 as WO 2019/071220, which is incorporated by reference herein in its entirety.

In some aspects, the amount of sensory modifier effective to decrease plant protein flavor can be the amount effective to reduce plant protein flavor intensity score by at least 1 unit relative to plant protein flavor intensity in an equivalent composition lacking the sensory modifier. The plant protein flavor intensity score is determined by at least three panelists trained in tasting plant protein compositions using a roundtable methodology using a scale of 0 to 9, where a score of 0 indicates no plant protein flavor and 9 indicates extreme plant protein flavor intensity (i.e., 0=not detected, 1=trace, 2=faint, 3=slight, 4=mild, 5=moderate, 6=definite, 7=strong, 8=very strong, 9=extreme). In some aspects, the plant protein flavor may be reduced by at least 2, at least 3, or at least 4 units. In some aspects, the plant protein flavor intensity may be evaluated by assaying beany, pea, corny, hay, green notes, barnyard, fermented, or waxy flavor intensity, where a decrease in beany, pea, corny, hay, green notes, barnyard, fermented, or waxy flavor intensity, respectively, demonstrates a decrease in plant protein flavor intensity.

In some aspects, the amount of sensory modifier effective to decrease saltiness can be the amount effective to reduce a saltiness intensity value, measured by the Standardized Saltiness Intensity Test with at least four panelists experienced in sensory testing, by at least 1 unit. In other aspects, the amount effective to decrease saltiness comprises an amount effective to reduce a saltiness intensity value, measured the same way, by at least 1 unit, 2 units, 3 units, 4 units, 5 units, 6 units, or more. In other aspects, the amount effective to decrease saltiness comprises an amount effective to reduce a saltiness intensity value, measured the same way, to below 7, 6, 5, 4, 3, or 2 units. In some aspects, the amount effective to decrease saltiness comprises an amount effective to reduce a saltiness intensity value, measured the same way, to zero. Similar test may be used to evaluate the amount of sensory modifier effective to decrease or increase in sweetness, sourness, bitterness, and umami in the described meat substitute compositions.

The meat substitute compositions can have various amounts of sensory modifier. Sensory modifier can be present in the meat substitute composition in any amount desired for the particular use. For example, the sensory modifier can be present in the meat substitute composition at a total concentration from 0.001% (wt) to 1.0% (wt), 0.001% (wt) to 0.5% (wt), 0.005% (wt) to 0.1% (wt), 0.005% (wt) to 0.050% (wt), or 0.005% (wt) to 0.02% (wt). The meat substitute composition may include the sensory modifier at a concentration of at least 0.001%, 0.002%, 0.005%, 0.01%, 0.02%, or 0.05% by weight of the meat substitute composition. The meat substitute composition may include the sensory modifier at a concentration up to 1.0% (wt), 0.5% (wt), 0.25% (wt), 0.2% (wt), 0.1% (wt), or 0.05% (wt).

The amount of an individual sensory modifier species in the various compositions described herewith can each independently vary. For example, monocaffeoylquinic acid, dicaffeoylquinic acid, or both, can each individually be present in the meat substitute composition at a concentration from about 1 ppm to about 1000 ppm. In some aspects, monocaffeoylquinic acid, dicaffeoylquinic acid, or both, can each individually be present in the meat substitute composition at a concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, 900 ppm to about 1000 ppm. In some aspects, monocaffeoylquinic acid, dicaffeoylquinic acid, or both, can each individually be present at a concentration of or greater than about 10, 50, 100, 200, 300, 400, 500, 600, 700, 800, 900, or 1000 ppm in the meat substitute composition. In some aspects, monocaffeoylquinic acid, dicaffeoylquinic acid, or both, can each individually be present in the met substitute composition at a concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, monocaffeoylquinic acid, dicaffeoylquinic acid, or both, can each individually be present in the meat substitute composition at a concentration from about 400 ppm to about 800 ppm.

### Botanical Source of Sensory Modifier

In various aspects, the sensory modifier can be isolated from botanical sources. Various botanical sources comprise sensory modifiers and sensory modifiers can be isolated from these botanical sources. Some examples of botanical sources from which sensory modifiers can be isolated include Eucommia ulmoides, honeysuckle, Nicotiana benthamiana, artichoke, globe artichoke, cardoon, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cowberry, huckleberry, grapes, chicory, eastern purple coneflower, echinacea, Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thom apple, Sweet potato, apple, Peach, Nectarine, Cherry, Sour cherry, Wild cherry, Apricot, Almond, Plum, Prune, Holly, Yerba mate, Mate, Guayusa, Yaupon Holly, Kuding, Guarana, Cocoa, Cocoa bean, Cacao, Cacao bean, Kola nut, Kola tree, Cola nut, Cola tree, Ostrich fern, Oriental ostrich fern, Fiddlehead fem, Shuttlecock fern, Oriental ostrich fern, Asian royal fern, Royal fern, Bracken, Brake, Common bracken, Eagle fem, Eastern brakenfem, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile.

Some botanical sources may produce sensory modifiers that are enriched for one or more of caffeic acid, monocaffeoylquinic acids, and dicaffeoylquinic acids. For example, sensory modifiers isolated from yerba mate plant (Ilex paraguariensis) are enriched for monocaffeoylquinic and dicaffeoylquinic acids. In other aspects, sensory modifiers isolated from yerba mate plant that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof. For example, sensory modifiers isolated from other botanical sources can be enriched for dicaffeoylquinic acids. In other aspects, sensory modifiers isolated from other botanical sources that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and salts thereof.

Sensory modifier may be isolated in a variety of ways. Some suitable processes are disclosed in more detail in U.S. application Ser. No. 16/373,206, filed Apr. 4, 2019 and entitled “Steviol Glycoside Solubility Enhancers,” which was published on Jul. 25, 2019 as US Patent Application Publication No. 2019/0223481; International Application No. PCT/US2018/054691, filed Oct. 5, 2018 and entitled “Steviol Glycoside Solubility Enhancers;” U.S. Provisional Application No. 62/569,279, filed Oct. 6, 2017, and entitled “Steviol Glycoside Solubility Enhancers;” U.S. application Ser. No. 16/374,894, filed Apr. 4, 2019 and entitled “Methods for Making Yerba Mate Composition,” which was published on Aug. 1, 2019 as US Patent Application Publication No. 2019/0231834; International Application No. PCT/US2018/054688, filed Oct. 5, 2018 and entitled “Methods for Making Yerba Mate Composition;” U.S. Provisional Application Ser. No. 62/676,722, filed May 25, 2018, and entitled “Methods for Making Yerba Mate Extract Composition;” and International Application No. PCT/US2020/026885 filed Apr. 6, 2020, entitled “Stevia Processing,” and published as WO 2020/210161 on Oct. 15, 2020, each of which is incorporated herein by reference. For example, sensory modifier may be isolated from a botanical source that comprises one or more of monocaffeoylquinic acid, dicaffeoylquinic acid, and salts thereof. For example, yerba mate biomass and stevia biomass can be used to prepare sensory modifier. In one exemplary process, sensory modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to ⅓ of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the sensory modifier. This process is also suitable to obtain sensory modifier from stevia biomass and can be adapted to obtain sensory modifier from other botanical sources for example those described above.

In some aspects, the sensory modifier can be a blend of sensory modifier isolated from more than one botanical source.

Some compounds can adversely impact flavor or aroma of an aqueous solution or meat substitute composition. Certain sensory modifiers, such as those prepared from plant extract do not include one or more of the compounds shown in Table 2, or any combination thereof, above the disclosed preferred content levels. All preferred content levels are stated as weight percent on a dry weight basis. Certain commercially desirable solid (dry) sensory modifiers do not include more than the preferred level of any of the compounds listed in Table 2. For those compounds listed that are acids, the compound may be present in acid form and/or in slat form.

TABLE 2

| Class of | Preferred Content | % wt of compounds in steviol glycoside |
|---|---|---|
| compounds | Level (% wt) | solubility enhancer solid (dry) compositions |
| Organic acids | <3%, preferably | malonate, malonic acid, oxalate, oxalic acid, |
| | <2%, <1%, or 0% | lactate, lactic acid, succinate, succinic acid, |
| | <0.5%, preferably | malate, malic acid, citrate, citric acid |
| | <0.25% or 0% | tartrate, tartaric acid, pyruvate, pyruvic acid, |
| | | fumarate, fumaric acid, ascorbic acid, sorbate, |
| | | sorbic acid, acetate, acetic acid |
| Inorganic acids | <1%, preferably | sulfate, sulfuric acid, phosphate, phosphoric |
| | <0.5% or 0% | acid, nitrate, nitric acid, nitrite, nitrous acid, |
| | | chloride, hydrochloric acid, ammonia, |
| | | ammonium |
| Flavanoids, | <5%, preferably | quercetin, kaempferol, myricetin, fisetin, |
| isoflavanoids, and | <4%, <3%, or <2%, | galangin, isorhamnetin, pachypodol, rhamnazin, |
| neoflavanoids | more preferably | pyranoflavonols, furanoflavonols, luteolin, |
| | <1%, <0.5%, or 0% | apigenin, tangeritin, taxifolin (or |
| | | dihydroquercetin), dihydrokaempferol, |
| | | hesperetin, naringenin, eriodictyol, |
| | | homoeriodictyol, genistein, daidzein, glycitein |
| Flavanoid | <5%, preferably | hesperidin, naringin, rutin, quercitrin, luteolin- |
| glycosides | <4%, <3%, or <2%, | glucoside, quercetin-xyloside |
| | more preferably | |
| | <1%, <0.5%, or 0% | |
| Anthocyanidins | <5%, preferably | cyanidin, delphinidin, malvidin, pelargonidin, |
| | <4%, <3%, or <2%, | peonidin, petunidin |
| | more preferably | |
| | <1%, <0.5%, or 0% | |
| Tannins | <1%, preferably | tannic acid |
| | <0.5%, <0.25%, or | |
| | 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, methionine, |
| | | phenylalanine, proline, serine, threonine, |
| | | tryptophan, tyrosine, and valine |
| Total Fat | <1%, preferably | monoglycerides, diglycerides, triglycerides |
| | <0.5%, <0.25%, or | |
| | 0% | |
| Monosaccharides, | <1% | glucose, fructose, sucrose, galactose, ribose, |
| disaccharides, and | | trehalose, trehalulose, lactose, maltose, |
| polysaccharides | | isomaltose, isomaltulose, mannose, tagatose, |
| | | arabinose, rhamnose, xylose, dextrose, erythrose, |
| | | threose, maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan |
| | | gum, cellulose, chitin, and chitosan |
| Steviol glycoside | <55% | stevioside; steviolbioside; rubusoside; 13- and |
| compounds | | 19-SMG; dulcosides A, B, C, D; and |
| | | rebaudiosides A, B, C, D, E, F, I, M, N, O, T |
| Saponins | <2%, preferably | glycosylated ursolic acid and glycosylated |
| | <1%, <0.5%, | oleanolic acid |
| | <0.25%, or 0% | |
| Terpenes other | <2%, preferably | eugenol, geraniol, geranial, alpha-ionone, beta- |
| than saponins and | <1%, <0.5%, | ionone, epoxy-ionone, limonene, linalool, |
| steviol glycoside | <0.25%, or 0% | linalool oxide, nerol, damascenone |
| compounds | | |
| Lipid oxidation | <2%, preferably | Decanone, decenal, nonenal, octenal, heptenal, |
| products | <1%, <0.5%, | hexenal, pentenal, pentenol, pentenone, |
| | <0.25%, or 0% | hexenone, hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, Fluorene, |
| | | Indeno(1,2,3-cd)pyrene, Naphthalene, |
| | | Phenanthrene, Pyrene |
| Other compounds | <0.1%, preferably | chlorophyll, furans, furan-containing chemicals, |
| | <0.05% or 0% | theobromine, theophylline, and trigonelline |
| | <1%, preferably | saponins |
| | <0.5%, <0.25%, or | |
| | 0% | |

In some aspects, the sensory modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

In some aspects, meat substitute compositions prepared using a sensory modifier described herein do not include certain compound(s) above a certain cutoff wt %. For example, the meat substitute can comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

The present invention can be better understood by reference to the following examples which are offered by way of illustration. The present invention is not limited to the examples given herein.

### EXAMPLES

### Materials and Methods

The tested sensory modifier was a mixture of monocaffeoylquinic and dicaffeoylquinic acids and salts prepared from yerba mate and having a ratio of salt fraction to acid fraction of 65:35. For some of the compositions, the sensory modifier was co-spray dried with a steviol glycoside. Table 3 lists the contents and source of various components.

TABLE 3

| Component | Ingredients | Source |
|---|---|---|
| Sensory Modifier | Mixture containing mono- and | Cargill, Inc. |
| | dicaffeoylquinic acids and salts, | (Wayzata, MN) |
| | prepared from Yerba mate | |
| | 65:35 ratio of salt:acid from | |

### Meat Substitute Assay

Assays were carried out to characterize the sensory attributes of meat substitute compositions with various amounts of sensory modifier. Sensory attributes of the compositions were tested by a panel of individuals that are experienced in sensory testing. The experienced panelists assessed sensory attributes such as, but not limited to, color, texture, plant-protein flavor, and plant-protein flavor masking. In some Examples, a roundtable methodology was used to assess various flavor attributes. To test each composition, the experienced panelists dispensed approximately 14 g of each composition into their own mouths, dispersed the composition by chewing and moving their tongues, and recorded a value or comments for the attribute(s) being tested. Between tasting compositions, the panelists were able to cleanse their palates with water.

### Plant Protein Assay

Assays were carried out to characterize the sensory attributes of plant-protein isolate solutions with various amounts of sensory modifier. Sensory attributes of the compositions were tested by a panel of individuals that are experienced in sensory testing. The experienced panelists assessed sensory attributes such as, but not necessarily limited to, bean flavor, hay flavor, mouth drying, creaminess, green pea flavor, bitterness, oil notes, corn flavor, starchy, barnyard flavor, sour, and astringency. Sensory attributes were scored on a scale of 0-9 with 0 indicating no sensory attribute intensity and 9 indicating an extreme sensory attribute intensity (i.e., 0=not detected, 1=trace, 2=faint, 3=slight, 4=mild, 5=moderate, 6=definite, 7=strong, 8=very strong, 9=extreme). In some Examples, a roundtable methodology was used to assess various flavor attributes. To test each composition, the experienced panelists dispensed approximately 2-5 ml of each solution into their own mouths, dispersed the solution by moving their tongues, and recorded a consensus sensory attribute scale value. Between tasting solutions, the panelists were able to cleanse their palates with water.

### Example 1—Pea Protein Patty

Pea protein patties were prepared with the ingredients outlined in Table 4. To prepare the pea protein patty samples, the textured pea protein was first hydrated with about half of the total water by mixing for about 5-7 minutes until the surface is dull and no longer shiny and no residual moisture is present at the bottom of the bowl. The soluble pea protein, methylcellulose metolose, and salt dry ingredients are mixed until homogeneous. The reminder of the total water is added to the homogeneous dry ingredients and mixed until a dough-like consistency is formed. The hydrated texturized pea component is then mixed with the dough-like hydrated dry ingredients until the mixture is well incorporated and no chunks remain. After cooling to below 4.4° C., coconut oil chips are added and mixed in until evenly incorporated. Approximately 113 g patties are formed from the mixture and frozen. The sensory modifier was added as outlined in Table 5.

TABLE 4

| | Sample | | | | | |
|---|---|---|---|---|---|---|
| Ingredient | 1.1 | 1.2 | 1.3 | 1.4 | 1.5 | 1.6 |
| Water | 65.00% | 64.94% | 64.94% | 64.94% | 64.99% | 65.00% |
| Textured pea | 15.00% | 14.99% | 14.99% | 14.99% | 15.00% | 15.00% |
| protein | | | | | | |
| Pea protein | 4.00% | 4.00% | 4.0% | 4.0% | 4.0% | 4.0% |
| isolate | | | | | | |
| Methyl- | 1.65% | 1.65% | 1.65% | 1.65% | 1.65% | 1.65% |
| cellulose | | | | | | |
| Salt (NaCl) | 1.00% | 1.00% | 1.00% | 1.00% | 1.00% | 1.00% |
| Coconut oil | 13.35% | 13.34% | 13.34% | 13.34% | 13.35% | 13.35% |
| Sensory | — | 0.10% | 0.10% | 0.10% | 0.02% | 0.01% |
| modifier | | | | | | |

TABLE 5

| Sample | Sensory Modifier Addition |
|---|---|
| 1.2 | Sensory modifier added to the water used to hydrate the matrix of dry |
| | ingredients |
| 1.3 | Sensory modifier added to the water used to hydrate the textured pea protein |
| 1.4 | Half of the sensory modifier added to the water used to hydrate the matrix of |
| | dry ingredients, half added to the water used to hydrate the textured pea protein |
| 1.5 | Sensory modifier added to the water used to hydrate the matrix of dry |
| | ingredients |
| 1.6 | Sensory modifier added to the water used to hydrate the matrix of dry |
| | ingredients |

### Example 2—Sensory Assessment of Pea Patty Samples

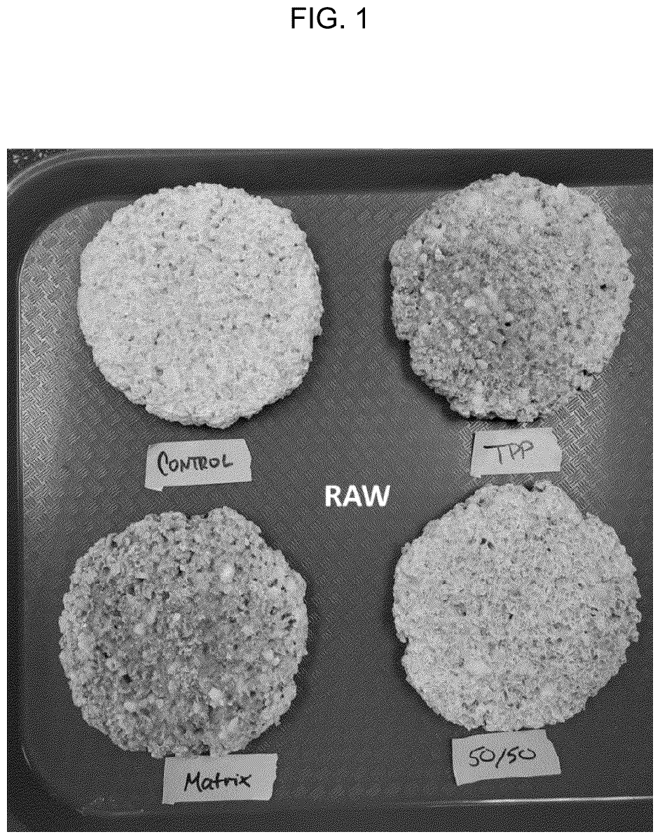

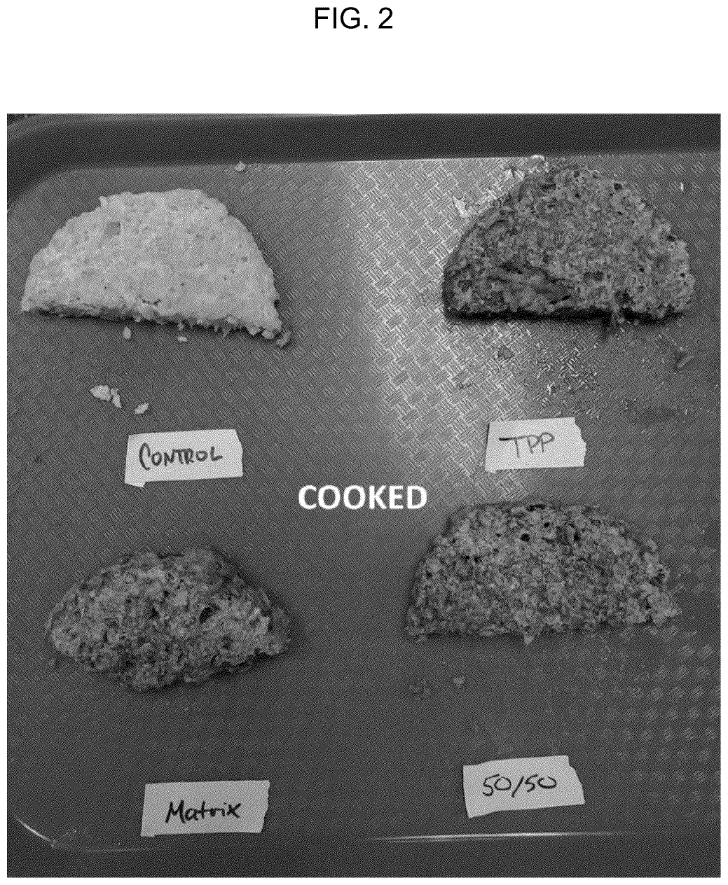

Assays were carried out to characterize the sensory attributes, including color, texture, and flavor, of the pea protein patty samples described in Example 1. Images of samples 1.1-1.4 before and after cooking are provided in FIG. 1 and FIG. 2, respectively. Color of each patty was assessed prior to cooking, with a score of 5 indicating a match to control sample 1.1 and score of 1 indicates a sample that is very different from control. Each of samples 1.1-1.4 were cooked to an internal temperature of 165° F. (i.e., about 73.9° C.) with browning on both sides of the patty. After cooking, color was again assessed using the same scale previously described. Texture and plant protein flavor were scored on the same 5-1 scale with 5 indicating a match to control sample 1.1 and 1 indicating a sample that is very different from control. Each of samples 1.2, 1.3, and 1.4 were also ranked based on how well the addition of the sensory modifier ingredient masked the flavor of the plant protein. The sensory results for Samples 1.1-1.4 are outlined in Table 6.

TABLE 6

| | | | | Plant | Plant Protein | |
|---|---|---|---|---|---|---|
| | Raw | Cooked | | Protein | flavor masking | |
| | color | Color | Texture | Flavor | ability | |
| Sample | (1-5) | (1-5) | (1-5) | (1-5) | (1-3, 1 is best) | Comments |
| 1.1 | 5 | 5 | 5 | 5 | — | Strong yellow color, |
| | | | | | | hay/farm flavor, fatty |
| | | | | | | shortening-like notes, |
| | | | | | | good bite, waxiness on |
| | | | | | | tongue |
| 1.2 | 1 | 1 | 5 | 2 | 1 | Not as much waxy |
| | | | | | | mouthfeel as 1.1, |
| | | | | | | consistent flavor, |
| | | | | | | gray/green hue, less of a |
| | | | | | | pea note on backend |
| 1.3 | 2 | 2 | 4 | 4 | 3 | Similar to control flavor, |
| | | | | | | wet hay note, quick |
| | | | | | | flavor note, not as dark |
| | | | | | | as 1.2 |
| 1.4 | 3 | 3 | 4 | 3 | 2 | Easier bite, flavor hits in |
| | | | | | | middle, lightest gray |
| | | | | | | color |

### Example 3—Sensory Assessment of Pea Protein Patty Samples

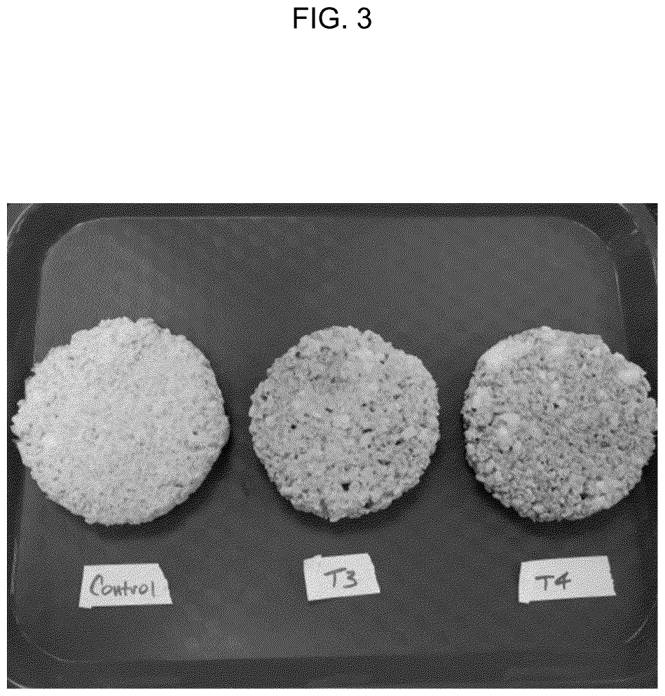

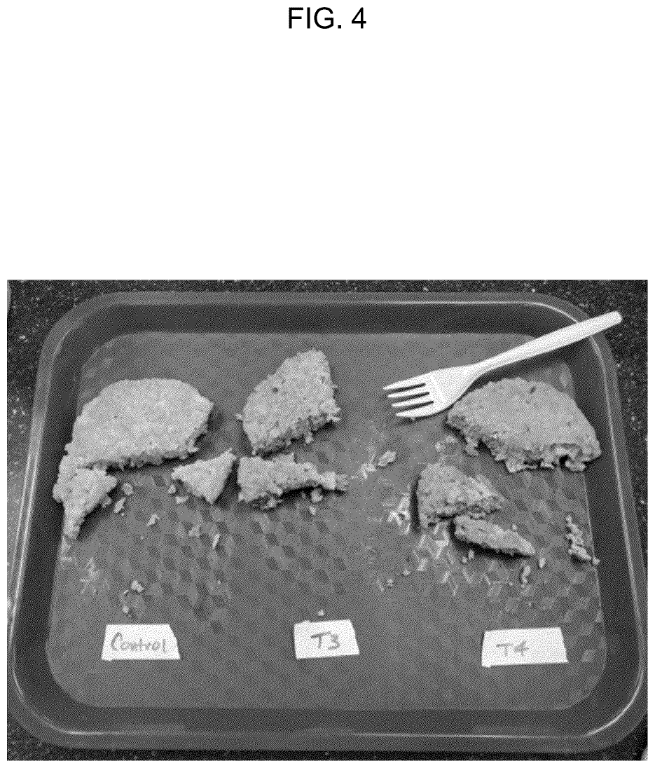

Assays were carried out to characterize the sensory attributes, including color, texture, and flavor, of the pea protein patty samples described in Example 1. Images of samples 1.1, 1.5, and 1.6 before and after cooking are provided in FIG. 3 and FIG. 4, respectively. Each of samples 1.1, 1.5, and 1.6 were cooked to an internal temperature of 165° F. (i.e., about 73.9° C.) with browning on both sides of the patty.

After cooking, sample 1.5 was characterized as having an herbal note with an appearance that was visually distinct from the control patty of sample 1.1. Sample 1.5 had less of the pea protein flavor and a general suppression of flavors. The flavor of sample 1.5 had a hay-like finish with some tea notes.

After cooking, sample 1.6 was characterized as having a more consistent flavor than control sample 1.1 without the pea or hay flavored aftertaste.

### Example 4—Sensory Assessment of Soy Protein Isolate Solutions

Assays were carried out to characterize the sensory attributes of soy protein isolate solutions. Bean flavor, hay flavor, mouth drying, and creaminess scores were determined by a panel of four individuals using a roundtable consensus approach. Panelists were experienced in sensory testing. All panelists used the plant protein assay method described above. Soy protein isolate solutions were prepared by mixing the soy protein isolate with water. For the compositions including the sensory modifier, the sensory modifier was added to the water prior to mixing with the soy protein isolate. The soy protein isolate solutions tested are outlined in Table 7.

TABLE 7

| | Samples | | | |
|---|---|---|---|---|
| Ingredient | 4.1 | 4.2 | 4.3 | 4.4 |
| Water | 98.0% | 97.995% | 97.9933% | 97.990% |
| Soy protein isolate | 2.0% | 2.0% | 2.0% | 2.0% |
| Sensory modifier | — | 0.005% | 0.0067% | 0.010% |

TABLE 8

| Sensory | Samples | | | |
|---|---|---|---|---|
| Attribute | 4.1 | 4.2 | 4.3 | 4.4 |
| Bean flavor | 6 | 4.5-5 | 4 | 4 |
| Hay flavor | 3-4 | 3 | 4.5 | 4.5 |
| Mouth drying | 5 | 4 | 5 | 4 |
| Creaminess | — | 2-3 | 1-2 | 1 |
| Comments | Upfront beany | Further delay in | Further delay in | Overall more |
| | note, hay flavor | onset and | onset and | cohesive flavor |
| | detected after | reduction in | reduction in | profile, faint sour |
| | dissipation of | intensity of | intensity of | note present |
| | beany note, latent | beany note | beany note | |
| | mouth drying | | | |
| | with trace to faint | | | |
| | bitterness | | | |

### Example 5—Sensory Assessment of Pea Protein Isolate Solutions

Assays were carried out to characterize the sensory attributes of pea protein isolate solutions. Green pea flavor, bitterness and oil/creamy scores were determined by a panel of three individuals using a roundtable consensus approach. Panelists were experienced in sensory testing. All panelists used the plant protein assay method described above. Pea protein isolate solutions were prepared by mixing the pea protein isolate with water. For the compositions including the sensory modifier, the sensory modifier was added to the water prior to mixing with the pea protein isolate. The pea protein isolate solutions tested are outlined in Table 9.

TABLE 9

| | Samples | | | |
|---|---|---|---|---|
| Ingredient | 5.1 | 5.2 | 5.2 | 5.4 |
| Water | 98.0% | 97.995% | 97.9933% | 97.990% |
| Pea protein isolate | 2.0% | 2.0% | 2.0% | 2.0% |
| Sensory modifier | — | 0.005% | 0.0067% | 0.010% |

TABLE 10

| Sensory | Samples | | | |
|---|---|---|---|---|
| Attribute | 5.1 | 5.2 | 5.3 | 5.4 |
| Green Pea | 6 | 5.5 | 5 | 4 |
| Flavor | | | | |
| Bitterness | 2 | 2 | 1.5 | 4 |
| Oil/Creamy | 3.5 | 2.5 | 1.5-2 | 1-2 |
| Comments | Long lasting pea | Delayed onset of | Further delay in | Initial bitterness |
| | flavor intensity | green pea flavor | onset of pea | with other |
| | with latent | | flavor, pea flavor | characteristic pea |
| | bitterness | | has lower | flavor, bitterness |
| | | | intensity with a | more noticeable, |
| | | | shorter time at | more delayed |
| | | | peak intensity | creamy note |

### Example 6—Sensory Assessment of Corn Protein Isolate Solutions

Assays were carried out to characterize the sensory attributes of corn protein isolate solutions. Corn intensity, starchy, and mouth drying scores were determined by a panel of six individuals using a roundtable consensus approach. Panelists were experienced in sensory testing. All panelists used the plant protein assay method described above. Corn protein isolate solutions were prepared by mixing the corn protein isolate with water. For the compositions including the sensory modifier, the sensory modifier was added to the water prior to mixing with the corn protein isolate. The corn protein isolate solutions tested are outlined in Table 11.

TABLE 11

| | Samples | | | |
|---|---|---|---|---|
| Ingredient | 6.1 | 6.2 | 6.3 | 6.4 |
| Water | 98.0% | 97.995% | 97.9933% | 97.990% |
| Corn protein isolate | 2.0% | 2.0% | 2.0% | 2.0% |
| Sensory modifier | — | 0.005% | 0.0067% | 0.010% |

TABLE 12

| Sensory | Samples | | | |
|---|---|---|---|---|
| Attribute | 6.1 | 6.2 | 6.3 | 6.4 |
| Corn Intensity | 6 | 5 | 4 | 4 |
| Starchy | 4 | 4 | 4 | 4 |
| Mouth Drying | 4.5 | 4.5 | 4 | 5 |
| Comments | Initial starchy | More cohesive | Further reduction | More muted |
| | note, transitions | flavor, consistent | in corn flavor | flavor upfront |
| | to corny flavor | corn flavor | intensity | resulting in |
| | which builds in | intensity | | watery |
| | intensity, hay | throughout, faint | | perception, slight |
| | note also present | sourness at the | | sourness at the |
| | at the end, | end | | end |
| | powdery and | | | |
| | gritty mouth feel | | | |

### Example 7—Sensory Assessment of Potato Protein Isolate Solutions

Assays were carried out to characterize the sensory attributes of potato protein isolate solutions. Barnyard flavor, sourness, astringency, and bitterness scores were determined by a panel of five individuals using a roundtable consensus approach. Panelists were experienced in sensory testing. All panelists used the plant protein assay method described above. Potato protein isolate solutions were prepared by mixing the potato protein isolate with water. For the compositions including the sensory modifier, the sensory modifier was added to the water prior to mixing with the potato protein isolate. The potato protein isolate solutions tested are outlined in Table 13.

TABLE 13

| | Samples | | | |
|---|---|---|---|---|
| Ingredient | 7.1 | 7.2 | 7.3 | 7.4 |
| Water | 98.0% | 97.995% | 97.9933% | 97.990% |
| Potato protein isolate | 2.0% | 2.0% | 2.0% | 2.0% |
| Sensory modifier | — | 0.005% | 0.0067% | 0.010% |

TABLE 14

| Sensory | Samples | | | |
|---|---|---|---|---|
| Attribute | 7.1 | 7.2 | 7.3 | 7.4 |
| Barnyard | 4 | 3 | 2 | 2 |
| Sour | 6 | 6 | 5.5 | 5 |
| Astringency | 7 | 7 | 6 | 6 |
| Bitterness | 5 | 4 | 3 | 4 |
| Comments | Immediate | Delay in sourness | Sour note | Further delay in |
| | sourness followed | onset and reduction | delayed but | sourness onset, |
| | by | in | also | longer lasting |
| | barnyard/fermented | barnyard/fermented | broadened, | barnyard/fermented |
| | flavor, strong | flavor, starchy | more | flavor in the finish |
| | astringency with | flavor and mouth | consistent | |
| | lingering bitter | coating present in | flavor | |
| | aftertaste | the finish | overall | |

### Example 8—Sensory Assessment of Plant Based Protein Solutions

Assays were carried out to characterize the sensory attributes of plant-based protein isolates from a variety of botanical sources. Sensory attribute intensity scores were determined by a panel of at least 6 individuals. Panelists were experienced in sensory testing. All panelists used the plant protein assay method described above, and individual sensory attribute intensity scores were averaged for reporting below. Plant-based protein solutions were prepared by mixing the plant-based protein isolate with water. For the compositions including the sensory modifier, the sensory modifier was added to the water prior to mixing with the plant-based protein isolate. The plant-based protein isolate solutions tested are outlined in Table 15.

TABLE 15

| | Ingredients | | | | |
|---|---|---|---|---|---|
| | | Protein Amount | Water | Sensory | |
| Samples | Protein source | (wt %) | (wt %) | Modifier (wt %) | pH |
| 8.1 | High Viscosity | 5 | 95 | 0 | 7.19 |
| | Chickpea | | | | |
| 8.2 | High Viscosity | 5 | 94.97 | 0.03 | 7.06 |
| | Chickpea | | | | |
| 8.3 | Low Viscosity | 5 | 95 | 0 | 6.61 |
| | Chickpea | | | | |
| 8.4 | Low Viscosity | 5 | 94.97 | 0.03 | 6.60 |
| | Chickpea | | | | |
| 8.5 | Rice | 5 | 95 | 0 | 5.58 |
| 8.6 | Rice | 5 | 94.97 | 0.03 | 5.60 |
| 8.7 | Sunflower | 5 | 95 | 0 | 6.05 |
| 8.8 | Sunflower | 5 | 94.97 | 0.03 | 6.03 |
| 8.9 | Potato | 5 | 95 | 0 | 7.02 |
| 8.10 | Potato | 5 | 94.97 | 0.03 | 6.94 |

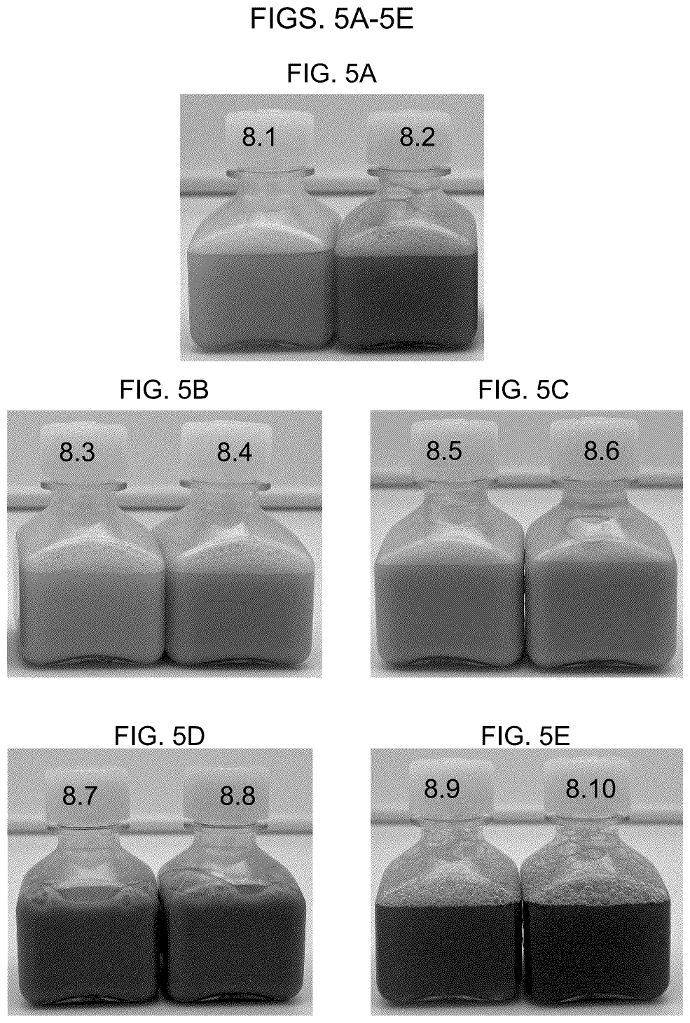

Most of the plant-based protein solutions had a pH close to neutral, except rice and sunflower protein which has a pH of 5.58 and 6.05, respectively. When sensory modifier was added to the chickpea and potato solutions, the solutions appeared a dark gray/green color (FIGS. 5A, 5B, and 5E). However, when the sensory modifier was added to the rice and sunflower solutions, no color change was observed (FIGS. 5C and 5D). The addition of the sensory modifier did not have a significant effect on pH (Table 15).

The sensory attributes of overall aroma and viscosity were evaluated for all samples. In addition to overall aroma and viscosity, the panelists collectively selected 4 additional sensory attributes that were most predominant for each plant-based protein source and compared said attributes between the samples prepared with and without the sensory modifier. The list of sensory attributes assayed for each plant-based protein source is shown in Tables 16-20 below and sensory attribute definitions are provided in Table 21. As shown in Table 16, the intensity of soy/tofu and what sensory attributes were reduced when the sensory modifier was added to the high viscosity chickpea protein solutions. For the low viscosity chickpea solutions, the addition of the sensory modifier decreased the intensity of astringency (Table 17). The addition of the sensory modifier to the solution of rice protein decreased the intensity of the play dough notes (Table 18). As shown in Table 19, the intensity of hully, cardboard, and astringency were reduced in the sunflower protein sample prepared with the sensory modifier. For the potato protein isolate solutions, the addition of the sensory modifier reduced the intensity of potato peel notes (Table 20).

TABLE 16

Sample

| Sensory Attribute | 8.1 | 8.2 |
|---|---|---|
| Overall Aroma | 6.3 | 5.7 |
| Bitter | 3.8 | 3.2 |
| Soy/Tofu | 4.3 | 3.3 |
| Wheat | 4.8 | 3.4 |
| Chalky | 2.3 | 2.2 |
| Viscosity | 4.5 | 4.0 |

TABLE 17

Sample

| Sensory Attribute | 8.3 | 8.4 |
|---|---|---|
| Overall Aroma | 6.2 | 6.0 |
| Bitter | 4.8 | 4.3 |
| Wheat | 4.3 | 3.5 |
| Astringency | 3.8 | 2.8 |
| Chalky | 5.2 | 4.7 |
| Viscosity | 3.7 | 3.5 |

TABLE 18

Sample

| Sensory Attribute | 8.5 | 8.6 |
|---|---|---|
| Overall Aroma | 5.5 | 5.1 |
| Flour | 4.2 | 3.3 |
| Play dough | 4.4 | 3.0 |
| Astringency | 5.4 | 4.6 |
| Chalky | 6.9 | 6.1 |
| Viscosity | 1.6 | 1.6 |

TABLE 19

Sample

| Sensory Attribute | 8.7 | 8.8 |
|---|---|---|
| Overall Aroma | 4.9 | 4.4 |
| Bitter | 3.4 | 2.9 |
| Hully | 4.9 | 3.7 |
| Cardboard | 4.7 | 3.7 |
| Astringent | 4.1 | 2.9 |
| Viscosity | 1.6 | 1.5 |

TABLE 20

Sample

| Sensory Attribute | 8.9 | 8.10 |
|---|---|---|
| Overall Aroma | 6.6 | 6.3 |
| Bitter | 3.1 | 2.9 |
| Earthy | 5.1 | 5.1 |
| Potato peel | 7.9 | 6.8 |
| Mushroom | 4.1 | 3.6 |
| Viscosity | 0.9 | 0.9 |

TABLE 21

| Modality | Attribute | Definition |
|---|---|---|
| Aroma | Overall aroma | Overall aroma |
| Taste | Bitter | Taste common to caffeine |
| Flavor | Soy/Tofu | The flavor reminiscent of say products such as tofu or |
| | | unsweetened soy milk. |
| | Wheat | The flavor associated with wheat ingredients, such as wheat |
| | | flour, wheat crackers, or wheat cereals |
| | Hully | The aromatics associated with the outer shell of a peanut |
| | Cardboard | The aromatics associated with wet brown cardboard boxes, |
| | | cereal boxes, shipping boxes |
| | Flour | The flavor reminiscent of white flour in water |
| | Earthy | The aromatics associated with decaying vegetation and damp, |
| | | black soil |
| | Potato peel | The aromatics associated with wet russet potato skins |
| | Mushroom | The earthy flavor of mushrooms, excluding any umami taste |
| | “Play-Doh” | The aromatics reminiscent of the play dough sold under the |
| | | tradename PLAY-DOH |
| Texture & | Astringent | Mouth drying sensation felt in different parts of the mouth |
| Mouthfeel | Chalky | Presence of very small powder or dusty like particles, leaving |
| | | a residual coating both in mouth and after expectorating |
| | Viscosity | The rate of the product to flow over tongue |

### Example 9—Sensory Assessment of Pea Protein Solutions

Assays were carried out to characterize the sensory attributes of various pea protein isolates. Pea protein isolates included standard isoelectric precipitation extracted pea protein, hydrolyzed pea protein, low-sodium pea protein, and enzyme modified pea protein. Sensory attribute intensity scores were determined by a panel of at least 5 individuals. Panelists were experienced in sensory testing. All panelists used the plant protein assay method described above, and individual sensory attribute intensity scores were averaged for reporting below. Pea protein solutions were prepared by mixing the pea protein isolate with water. For the compositions including the sensory modifier, the sensory modifier was added to the water prior to mixing with the pea protein isolate. The pea protein isolate solutions tested are outlined in Table 21.

TABLE 22

| | Ingredients | | | | |
|---|---|---|---|---|---|
| | | Protein Amount | Water | Sensory | |
| Samples | Protein source | (wt %) | (wt %) | Modifier (wt %) | pH |
| 9.1 | standard isoelectric | 5 | 95 | 0 | 7.47 |
| | precipitation extracted | | | | |
| | pea protein | | | | |
| 9.2 | standard isoelectric | 5 | 94.97 | 0.03 | 7.38 |
| | precipitation extracted | | | | |
| | pea protein | | | | |
| 9.3 | hydrolyzed pea protein | 5 | 95 | 0 | 7.32 |
| 9.4 | hydrolyzed pea protein | 5 | 94.97 | 0.03 | 7.26 |
| 9.5 | enzyme modified pea | 5 | 95 | 0 | 6.97 |
| | protein | | | | |
| 9.6 | enzyme modified pea | 5 | 94.97 | 0.03 | 6.90 |
| | protein | | | | |
| 9.7 | low-sodium pea | 5 | 95 | 0 | 7.42 |
| | protein | | | | |
| 9.8 | low-sodium pea | 5 | 94.97 | 0.03 | 7.33 |
| | protein | | | | |

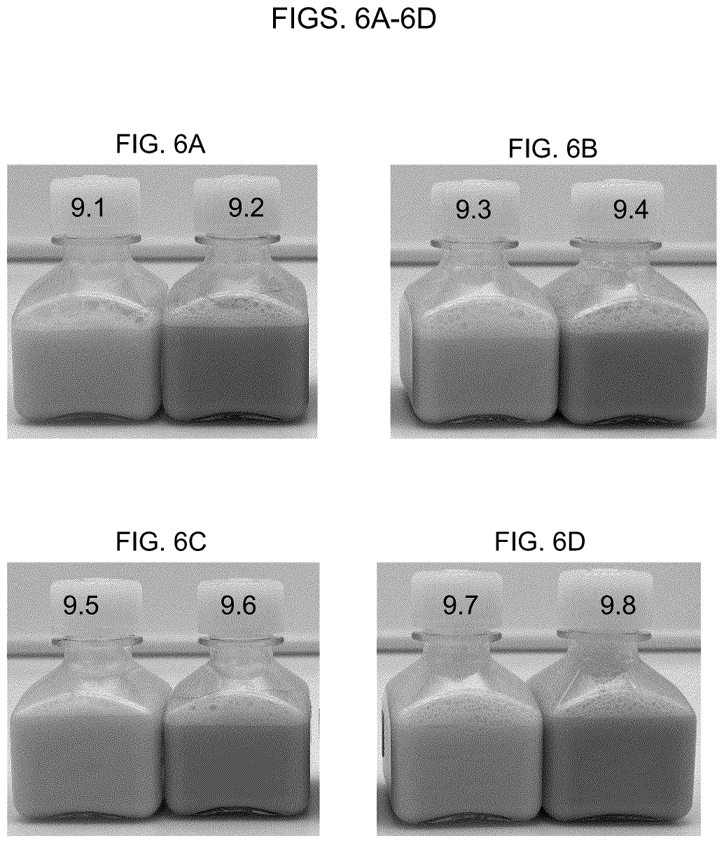

Most of the plant-based protein solutions had a pH close to neutral. The addition of the sensory modifier did not have a significant effect on pH (Table 22). When sensory modifier was added to the pea protein isolate solutions, the solutions appeared a dark gray/green color (FIGS. 6A-6D).

The sensory attributes of biller and viscosity were evaluated for all samples. In addition to biller and viscosity, the panelists collectively additional sensory attributes that were most predominant for each pea protein isolate and compared said attributes between the samples prepared with and without the sensory modifier. Sensory attribute definitions are provided in Table 24. The list of sensory attributes assayed for each plant-based protein source is shown in Table 23.

As shown in Table 23, samples that included the sensory modifier had a reduction in the intensity of one or more sensory attributes relative to the equivalent pea protein isolate solution without the sensory modifier. For example, when the sensory modifier was added to the standard pea protein isolate, the sample had decreased bitter, pea, and grassy/green intensity. In samples prepared with hydrolyzed pea protein, the sample with the sensory modifier had reduced bitter intensity relative to the sample without the sensory modifier. For the samples prepared with the enzyme modified pea protein, addition of the sensory modifier showed a reduction in pea and green/grassy intensity. Finally, the sample with the low sodium and the sensory modifier had reduced bitter, pea, astringency, and chalkiness intensity relative to the sample with pea protein isolate alone.

TABLE 23

| Sensory | Sample | | | | | | | |
|---|---|---|---|---|---|---|---|---|
| Attribute | 9.1 | 9.2 | 9.3 | 9.4 | 9.5 | 9.6 | 9.7 | 9.8 |
| Bitter | 4.8 | 2.6 | 7.7 | 6.2 | 2.6 | 2.5 | 6.8 | 5.4 |
| Pea | 4.7 | 3.3 | — | — | 4.3 | 2.6 | 3.6 | 2.6 |
| Green/Grassy | 5.4 | 4.2 | 2.8 | 2.8 | 3.1 | 1.7 | — | — |
| Viscosity | 3.2 | 3.2 | 2.4 | 2.0 | 4.1 | 3.5 | 2.5 | 2.6 |
| Astringent | — | — | 5.6 | 5.2 | — | — | 4.3 | 2.9 |
| Chalky | — | — | 6.2 | 5.4 | — | — | 6.1 | 4.9 |

Blank spaces indicate sensory attribute(s) that were not assessed for the given sample

TABLE 24

| Modality | Attribute | Definition |
|---|---|---|
| Taste | Bitter | Taste common to caffeine |
| Flavor | Pea | The aromatics associated with cooked split peas |
| | Green/Grassy | The aromatics associated with freshly cut vegetation |
| Texture & | Astringent | Mouth drying sensation felt in different parts of the mouth |
| Mouthfeel | Chalky | Presence of very small powder or dusty like particles, leaving a |
| | | residual coating both in mouth and after expectorating |
| | Viscosity | The rate of the product to flow over tongue |

1. A meat substitute composition comprising:
at least 2.0% (wt) of a plant-based protein; and
between 0.001% (wt) and 1.0% (wt) of a sensory modifier comprising
a dicaffeoylquinic acid or salt thereof; and
at least one compound selected from the group consisting of monocaffeoylquinic acids, monoferuloylquinic acids, diferuloylquinic acids, monocoumaroylquinic acids, dicoumaroylquinic acids, and salts thereof.

2. (canceled)

3. (canceled)

4. The composition of claim 1, wherein the sensory modifier is 0.01% to 0.5% by weight of the composition.

5. The composition of claim 1, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and wherein the sensory modifier comprises a monocaffeoylquinic component selected from the group consisting of chlorogenic acid, neochlorogenic acid, cryptochlorogenic acid, and salts thereof.

6. The composition of claim 1, wherein the total of all dicaffeoylquinic acids and dicaffeoylquinic salts present in the sensory modifier comprises 20% (wt) or more of a total weight of the sensory modifier.

7. (canceled)

8. The composition of claim 1, wherein the sensory modifier comprises a monocaffeoylquinic component and a dicaffeoylquinic component that together comprise more than 50% (wt) of the sensory modifier.

9. The composition of claim 1, wherein the plant-based protein is selected from the group consisting of pea protein, soy protein, corn protein, potato protein, wheat protein, pulse protein, chickpea protein, canola protein, rice protein, sunflower protein, and combinations thereof.

10. The composition of claim 1, wherein the meat substitute comprises between 50% (wt) and 80% (wt), of water.

11. The composition of claim 1, wherein the meat substitute comprises between 1% and 25%, by weight of lipid composition.

12.-16. (canceled)

17. The composition of claim 1, wherein the meat substitute comprises methylcellulose in an amount between 0.1% and 2% by weight.

18.-20. (canceled)

21. A method for decreasing plant protein flavor in a meat substitute composition, the method comprising,
adding to a meat substitute composition comprising a plant-based protein a sensory modifier to make a modified meat substitute composition, the sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof,
wherein, when cooked to an internal temperature of 73.9° C., plant protein flavor of the modified meat substitute composition is reduced relative to plant protein flavor in an equivalent meat substitute composition prepared without the sensory modifier.

22.-39. (canceled)

40. A method for preparing a meat substitute composition with reduced plant-based protein flavor, the method comprising:
(i) hydrating a textured plant-based protein with a first portion of water;
(ii) combining a soluble plant-based protein, a gelling agent, and a second portion of water to form a dough;
(iii) mixing the hydrated textured plant-based protein to the dough; and
(iv) adding a lipid composition to the hydrated textured plant-based protein dough mixture
wherein a sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof, is added in step (i), step (ii), step (iii), step (iv) or a combination thereof at a concentration of 0.001% to 1.0% by weight of the final meat substitute composition.

41. The method of claim 40, wherein the meat substitute comprises between 50% (wt) and 80% (wt) of water.

42. The method of claim 40, wherein the meat substitute composition comprises between 1% and 10% by weight of the lipid composition.

43. The method of claim 40, wherein the lipid composition comprises vegetable oil, coconut oil, palm oil, sunflower oil, soy oil, canola oil, or combinations thereof.

44. The method of claim 40, wherein the meat substitute composition comprises between 5% and 30% by weight of a textured plant-based protein.

45. The method of claim 40, wherein the textured plant-based protein comprises textured pea protein, textured soy flour, textured soy concentrate, textured wheat protein, textured potato protein, or combinations thereof.

46. The method of claim 40, wherein the meat substitute composition comprises between 0.5% and 8% by weight of a soluble powdered plant-based protein.

47. The method of claim 40, wherein the soluble powdered plant-based protein comprises pea protein isolate, defatted soy flour, defatted soy isolate, defatted soy concentrate, vital wheat gluten, potato protein, corn protein isolate, or combinations thereof.

48. The method of claim 40, wherein the meat substitute composition comprises methylcellulose in an amount between 0.5% and 2% by weight.

49. (canceled)

50. The method of claim 40, wherein the meat substitute comprises between 0.001% (wt) and 0.5% (wt) of the sensory modifier.

51. The method of claim 40, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and wherein the sensory modifier comprises a monocaffeoylquinic component selected from the group consisting of chlorogenic acid, neochlorogenic acid, cryptochlorogenic acid, and salts thereof.

52. The method of claim 40, wherein the total of all dicaffeoylquinic acids and dicaffeoylquinic salts present in the sensory modifier comprises 20% (wt) or more of a total weight of the sensory modifier.

53. The method of any claim 40, wherein the sensory modifier comprises a monocaffeoylquinic component and a dicaffeoylquinic component that together comprise more than 50% (wt) of the sensory modifier.
